(19) United States
(12) Patent Application Publication
(10) Pub. No.: US 2026/0042070 A1
(43) Pub. Date: Feb. 12, 2026

(54) STATIC MIXER

(71) Applicant: Global Analyzer Systems Limited, Calgary (CA)

(72) Inventors: Kelly PICKRELL, Calgary (CA); Charles Anim ODAME-ANKRAH, Calgary (CA)

(73) Assignee: Global Analyzer Systems Limited, Calgary (CA)

(21) Appl. No.: 19/291,681

(22) Filed: Aug. 6, 2025

Related U.S. Application Data
(60) Provisional application No. 63/679,802, filed on Aug. 6, 2024.

(51) Int. Cl. B01F 25/431; B01F 23/10; B01F 25/00; B01F 35/50; B01F 35/513; B01F 101/00; B01J 12/00; B01J 19/24; B01J 19/30; C01B 21/36

(52) U.S. Cl. CPC B01F 25/431; B01F 23/10; B01F 35/513; B01F 35/514; B01J 12/00; B01J 19/2405; B01J 19/2415; B01J 19/30; C01B 21/36; B01F 2025/916; B01F 2101/2204; B01F 2215/0431; B01J 2219/30207

(57) ABSTRACT

The present disclosure provides a static mixer for mixing two or more fluids together. The static mixer comprises a tubular body defining a mixing chamber in which spheroidal bodies are positioned. The spheroidal bodies are arranged sequentially within the mixing chamber, and their size and shape is selected so that they maintain a staggered formation. The tubular body can receive a flow of the two or more fluids at one end and convey them towards an opposite end where a mixed product can be provided. The arrangement of the spheroidal bodies can induce turbulence in the flow of the two or more fluids to mix them as they meander around the spheroidal bodies. The present disclosure further provides a method for mixing two or more fluids by the static mixer.

### RELATED APPLICATION(S)

This application claims the benefit of priority of U.S. Provisional Ser. No. 63/679,802 filed on Aug. 6, 2024, the contents of which are all incorporated by reference as if fully set forth herein in their entirety.

### FIELD AND BACKGROUND OF THE INVENTION

This invention generally relates to a device and a method for mixing fluids, and more specifically relates to a static mixer for gas phase chemistry of nitric oxide and ozone.

Static mixers are devices without moving parts that are used to mix fluids. These devices typically comprise a tube or hollow body in which stationary fixtures have been inserted. Fluids may be introduced at one end of the tube or hollow body and may flow towards an opposing end from which they may be collected as a mixed product. While flowing through the static mixer, the fluids encounter the stationary fixtures and flow around them. These interruptions in the flow can produce turbulence, shear forces, and/or divisions within the flow that cause the fluids to mix with each other. Because static mixers lack moving parts, they do not require an external power source to operate and are typically reliable.

Tubular static mixers generally have stationary fixtures that are either helical, obstructive, or a combination thereof. Helical fixtures have a blade-like structure that is twisted about a longitudinal axis of the tubular body to guide the flow of fluids, akin to a screw or playground slide. Helical fixtures can be aperiodic or interrupted, and can have twists of varying pitches. Obstructive fixtures are usually flat blade-like structures of various orientations and geometries that partially block or divert the flow of fluids. Examples of obstructive fixtures include plates, baffles, and lattices. In some static mixers, helical and obstructive elements are combined and, in some cases, augmented with elements such as counter-twists, perforations, and channels.

Static mixers are commonly used for chemical processing, drug production, water treatment, food processing, and oil and gas processing, among other things. NO, O₃, and NO₂ are all harmful pollutants, and their measurement is needed for obtaining knowledge on industry processes, ameliorating pollution, ensuring regulatory compliance, and informing government policy. Various methods have been developed to measure the concentration of NO₂ in ambient air, such as cavity ring-down spectroscopy, cavity-attenuated phase shift spectroscopy, and chemiluminescence spectroscopy.

Static mixers are needed to efficiently react nitric oxide (NO) and ozone (O₃) to produce nitrogen dioxide (NO₂). Converting NO to NO₂ can improve sensitivity and detection limits of NO₂ analyzers, making them more effective for low-concentration measurements.

Mixers typically work by introducing a controlled excess amount of ozone to a stream containing NO to achieve a rapid reaction between NO and O₃ to produce as shown below:

NO+O₃→NO₂+O₂

However, in excess O₃, there could be losses of NO₂ due reactions below:

NO₂+O₃→NO₃

NO₃+NO₂→N₂O₅

Existing static mixers, such as those described above with helical or obstructive features, are inefficient for converting flows of NO and O₃ to NO₂. To achieve a full, or almost full, conversion, the devices must be long, which makes them cumbersome and costly. Designs for static mixers without helical or obstructive features are also available. In one example, layers of zirconium oxide beads are stacked upon each other to form the stationary fixtures of a static mixer designed for liquid chromatography. The layers of beads define at each layer a plurality of mixing chambers through which fluids may flow. However, the availability of multiple flow paths between the layers can prevent the fluids from mixing efficiently or altogether. Furthermore, multiple flow paths can lead to hysteresis and inconsistencies in mixing.

Development and use of a static mixer capable of converting NO and ozone to NO₂ are needed for accurate air quality monitoring, regulatory compliance, research applications, and improved instrument performance.

Therefore, there is a need for simple and improved static mixers that can overcome one or more of the limitations of the existing technologies.

### SUMMARY OF THE INVENTION

An object of the present invention is to provide a static mixer.

In accordance with an aspect of the present invention, there is provided a static mixer for mixing two or more fluids to provide a fluid product, the static mixer comprising:
a tubular mixer body having a first end and a second end, the tubular mixer body defining a mixing chamber having a chamber surface defining an inner diameter, a first end opening, and a second end opening opposite the first end opening, the mixing chamber being configured to receive a flow of the two or more fluids into the first end opening of the tubular mixer body and convey the flow of the two or more fluids toward the second end opening; and a mixing component comprising a plurality of spheroidal bodies located in the mixing chamber of the tubular mixer body, each of the plurality of spheroidal bodies having an outer diameter more than 50% of the inner diameter of the mixing chamber, wherein each of the plurality of spheroidal bodies is maintained in contact with adjacent spheroidal bodies and with the chamber surface of the mixing chamber, and wherein the plurality of spheroidal bodies is configured to induce turbulence in the flow of the two or more fluids to produce the fluid product when the two or more fluids are conveyed through the mixing chamber.

### BRIEF DESCRIPTION OF THE SEVERAL VIEWS OF THE DRAWING(S)

Numerous other features, objects and advantages of the invention will become apparent from the following description when read in conjunction with the accompanying drawings.

FIG. 1A illustrates a top-down view of a static mixer in accordance with an embodiment of the present disclosure.

FIG. 1B illustrates a cross-sectional side view of a static mixer in accordance with an embodiment of the present disclosure.

FIG. 2 illustrates a partial cross-sectional side view of a static mixer in accordance with an embodiment of the present disclosure.

FIG. 3A illustrates a transverse cross-sectional view of a static mixer in accordance with an embodiment of the present disclosure.

FIG. 3B illustrates another transverse cross-sectional view of a static mixer in accordance with an embodiment of the present disclosure.

FIG. 3C illustrates another transverse cross-sectional view of a static mixer in accordance with an embodiment of the present disclosure.

FIG. 4 illustrates an example of a stopper in accordance with an embodiment of the present disclosure.

FIG. 5 illustrates a static mixer with fasteners in accordance with an embodiment of the present disclosure.

FIG. 6 illustrates bending of a flexible static mixer according to an embodiment of the present disclosure.

FIG. 7 illustrates a flowchart of a method for mixing fluids by a static mixer in accordance with an embodiment of the present disclosure.

### DESCRIPTION OF SPECIFIC EMBODIMENTS OF THE INVENTION

### Definitions

Unless defined otherwise, all technical and scientific terms used herein have the same meaning as commonly understood by one of ordinary skill in the art to which this invention belongs.

As used herein, the term “UV” refers to ultraviolet radiation in the region of electromagnetic spectrum including wavelengths from 40 to 4000 Å (4 to 400 nm).

As used herein, the term “fluid” refers to a substance that can flow and conform to the shape of a container. The term encompasses liquids, gases, gels, and combinations thereof.

As used herein, the term “spheroidal”refers to an approximate resemblance to a sphere.

As used herein, the term “adjacent” includes approximately proximal to, nearby or beside.

As used herein, the term “inert” includes being chemically inert, non-reactive, and/or non-catalytic.

As used herein, the term “about” refers to approximately a +/−10% variation from a given value. It is to be understood that such a variation is always included in any given value provided herein, whether or not it is specifically referred to.

The articles “a” and “an” are used herein to refer to one or to more than one (i.e., to at least one) of the grammatical object of the article. By way of example, “an element” means one element or more than one element.

A first aspect of the present disclosure provides a static mixer for mixing two or more fluids to form a fluid product.

The present disclosure relates to a static mixer which is simple to make, and which can achieve an efficient low pressure mixing of fluids with a small footprint. The static mixer of the present application permits a short overall length, minimum usage of materials so that weight is minimized and overall manufactured cost is low. In addition, manufacturing consistency can be very high as the spheroidal bodies can self-stagger.

The static mixer of the present disclosure comprises a tubular mixer body having a first end and a second end, and defining a mixing chamber that has a chamber surface defining an inner diameter, a first end opening, and a second end opening opposite the first end opening. The mixing chamber is configured to receive a flow of two or more fluids into the first end opening and convey the flow toward the second end opening. The static mixer further comprises a mixing component including a plurality of spheroidal bodies located in the mixing chamber Each of the plurality of spheroidal bodies is maintained in contact with adjacent spheroidal bodies and with the chamber surface of the mixing chamber.

The outer diameter of each spheroidal body of the plurality of spheroidal bodies can be a dimension of the respective spheroidal body along a direction transverse to the tubular mixer body.

The outer diameter of each spheroidal body can be selected to be greater than 50% of the inner diameter of the mixing chamber to prevent each spheroidal body from aligning with a neighboring spheroidal body in a direction transverse to the tubular mixer body.

In some embodiments, each spheroidal body of the plurality of spheroidal bodies can have an outer diameter that is between about 55% and about 95% of the inner diameter of the mixing chamber. In some embodiments, each spheroidal body of the plurality of spheroidal bodies can have an outer diameter that is from about 65% to about 75% of the inner diameter of the mixing chamber.

The plurality of spheroidal bodies is configured to induce turbulence in the flow of the two or more fluids to produce the fluid mixture when the two or more fluids are conveyed through the mixing chamber.

The spheroidal bodies can force the turbulence and mixing to occur over the entire length of the mixer. As there are no “dead spots” in the internal volume of the mixer, the turbulence is forced to occur from the start to the end.

The plurality of spheroidal bodies can define, in the mixing chamber, a peculiar flow path for the flow of the two or more fluids when the flow is received into the first end opening and conveyed toward the second end opening.

The flow path can separate and join over and over again which can increase mixing efficiency.

The fluid product can be a mixture and/or a reaction product of the two or more fluids. In some embodiments, the fluid product is a mixture of the two or more fluids. In some embodiments, the fluid product is a product of a reaction between the two or more fluids. In some embodiments, the fluid product is a solution of the two or more fluids.

The tubular mixer body can be a cylindrical tube. The tubular mixer body can be straight, flexible, or pre-deformed into a fixed shape.

The tubular mixer body can be made of a material that is transparent, translucent, or opaque. In some embodiments, the tubular mixer body is made of a material that is transparent to UV light. The tubular mixer body can further be made of a material with any rigidity. In some embodiments, the tubular mixer body is made of a material that is flexible.

The tubular mixer body can further be made of a material that is inert to the two or more fluids and/or the fluid product.

In some embodiments, the tubular mixer body can be made of a material selected from the group consisting of glasses, quartz, plastics, polymers, metals, rubbers, and ceramics. Metals includes stainless steel, nickel, and chromium-plated metals. Plastics and polymers includes poly(methyl methacrylate), polytetrafluoroethylene, perfluoroalkoxy alkanes (PFAs), polypropylenes, nylons, polyethylenes, polycarbonates, and polyamide-imides. Rubbers includes fluoroelastomers and silicones. Ceramics includes aluminum oxide, zirconium oxide, silicon nitride, and silicon carbide. The tubular mixer body can further be made of a material that is minimally porous, and/or that the two or more fluids and/or the fluid product do not adhere to.

The chamber surface of the mixing chamber can have a coating. In some embodiments, the coating of the chamber surface is inert to the two or more fluids and/or the fluid product.

In some embodiments, the fluid product is a product of a reaction between the two or more fluid products that is catalyzed by the coating of the chamber surface. The chamber surface of the mixing chamber can further have any roughness. In some embodiments, the chamber surface and/or the coating is smooth.

The plurality of spheroidal bodies can be arranged sequentially along and alternatingly about a central axis of the tubular mixer body. The plurality of spheroidal bodies can be arranged to form a staggered or zig-zag pattern in the mixing chamber. In some embodiments, the plurality of spheroidal bodies are arranged by close packing of the plurality of spheroidal bodies in the mixing chamber.

In some embodiments, the spheroidal bodies arrange themselves automatically into the staggered pattern.

The outer diameter of each spheroidal body of the plurality of spheroidal bodies can be a dimension of the respective spheroidal body along a direction transverse to the tubular mixer body. The outer diameter of each spheroidal body can be selected to be greater than 50% of the inner diameter of the mixing chamber to prevent each spheroidal body from aligning with a neighboring spheroidal body in a direction transverse to the tubular mixer body.

Each spheroidal body of the plurality of spheroidal bodies can have a shape selected from the group consisting of spheres, polyhedrons, ellipsoids, and ovoids. In some embodiments, each spheroidal body has a shape selected from the group consisting of octahedra, dodecahedra, and icosahedra. In some embodiments, each spheroidal body has a shape of a truncated polyhedron, a regular polyhedron, a prolate spheroid, or an oblate spheroid. In some embodiments, the spheroidal bodies are not identically shaped. In some embodiments, each spheroidal body has a same shape.

Each of the plurality of spheroidal bodies can be made of a material that is inert to the two or more fluids and/or the fluid product. In some embodiments, each of the spheroidal bodies is made of a material selected from the group consisting of glasses, quartz, plastics, polymers, metals, rubbers, and ceramics. Metals include stainless steel, nickel, and chromium-plated metals. Plastics and polymers include poly(methyl methacrylate), polytetrafluoroethylenes, PFAs, polypropylenes, nylons, polyethylenes, polycarbonates, and polyamide-imides. Rubbers include fluoroelastomers and silicones. Ceramics include aluminum oxide, zirconium oxide, silicon nitride, and silicon carbide. Each of the plurality of spheroidal bodies can further be made of a material that is minimally porous, and/or that the two or more fluids and/or the fluid product do not adhere to.

Each of the plurality of spheroidal bodies can have a coating. In some embodiments, the coating of each spheroidal body is inert to the two or more fluids and/or the fluid product. In some embodiments, the fluid product is a product of a reaction between the two or more fluid products that is catalyzed by the coating of each spheroidal body.

The plurality of spheroidal bodies can include a first set of spheroidal bodies and a second set of spheroidal bodies. The first set of spheroidal bodies can have a first average outer diameter and the second set of spheroidal bodies can have a second average outer diameter that is different from the first average outer diameter.

The static mixer can further comprise a first stopper and a second stopper. The first stopper can be positioned in the tubular mixer body adjacent the first end opening and can be configured to admit the two or more fluids into the mixing chamber. The second stopper can be positioned in the tubular mixer body adjacent the second end opening and can be configured to discharge the fluid product out of the mixing chamber. Each of the first stopper and the second stopper can be configured to retain the plurality of spheroidal bodies in the mixing chamber.

In some embodiments, each of the first stopper and the second stopper have a V-shaped cross section. In some embodiments, each of the first stopper and the second stopper have a prismatic shape. In some embodiments, each of the first stopper and the second stopper have a toroidal shape. In some embodiments, each of the first stopper and the second stopper is made of a material that is inert to the two or more fluids and/or the fluid product. In some embodiments, each of the first stopper and the second stopper is made of a material selected from the group consisting of glasses, quartz, plastics, polymers, metals, rubbers, and ceramics. Metals include stainless steel, nickel, and chromium-plated metals. Plastics and polymers include poly(methyl methacrylate), polytetrafluoroethylenes, PFAs, polypropylenes, nylons, polyethylenes, polycarbonates, and polyamide-imides. Rubbers include fluoroelastomers and silicones. Ceramics include aluminum oxide, zirconium oxide, silicon nitride, and silicon carbide. In some embodiments, the first stopper and the second stopper are maintained in position by tube compression fittings, bonding, swaging, and/or barbed connectors.

the tubular mixer body has a first tapered portion at the first end of the tubular mixer body and a second tapered portion at the second end of the tubular mixer body. The first tapered portion is designed to contain the first stopper in the tubular mixer body at the first end, and the second tapered portion is designed to contain the second stopper in the tubular mixer body at the second end. In some embodiments, each of the first stopper and the second stopper are designed to prevent the plurality of spheroidal bodies from obstructing the flow of the two or more fluids at the first tapered portion and at the second tapered portion, respectively.

In some embodiments, the first tapered portion and the second tapered portion have a non-circular cross-section designed to contain the plurality of spheroidal bodies while permitting the flow of the two or more fluids.

In some embodiments, the static mixer further comprises a first fastener positioned outside the first end of the tubular mixer body and a second fastener positioned outside the second end of the tubular mixer body, wherein the first fastener and the second fastener respectively define the first tapered portion and the second tapered portion. In some embodiments, each of the first fastener and the second fastener is a nut or ferrule. In some embodiments, each of the first fastener and the second fastener provides a connection point to the static mixer. In some embodiments, each of the first fastener and the second fastener is a tube compression fitting.

The flow of the two or more fluids can be received into the first end opening of the tubular mixer body at a first pressure and the fluid product can be discharged at the second end opening of the tubular mixer body at a second pressure that is lower than the first pressure.

The mixing chamber can preferably have a length of between about 100 mm and about 2000 mm. The inner diameter of the mixing chamber can preferably be between 1 and 10 mm. The plurality of spheroidal bodies can include from about 10 to about 2000 spheroidal bodies.

The static mixer of the present disclosure can be used to achieve an efficient mixing of NO and O₃. In some embodiments, the mixing chamber has a length sufficient to ensure that the NO and O₃ mix, by the turbulence, to produce NO₂ as the fluid product is conveyed toward the second end opening of the tubular mixer body.

In accordance with a second aspect of the present disclosure, there is provided a method for mixing two or more fluids to produce a fluid product using the static mixer, as described in relation to the first aspect. The method comprises: receiving, by the first end opening at the first end of the tubular mixer body, a flow of the two or more fluids into the mixing chamber of the tubular mixer body; passing the flow of two or more fluids through the mixing chamber towards the second end opening at the second end of the tubular mixer body; inducing, by the plurality of spheroidal bodies positioned in the mixing chamber, turbulence in the flow of the two or more fluids to mix the two or more fluids; and providing, at the second end of the tubular mixer body, the flow of the fluid product.

To gain a better understanding of the invention described herein, the following examples are set forth. It will be understood that these examples are intended to describe illustrative embodiments of the invention and are not intended to limit the scope of the invention in any way.

### EXAMPLES

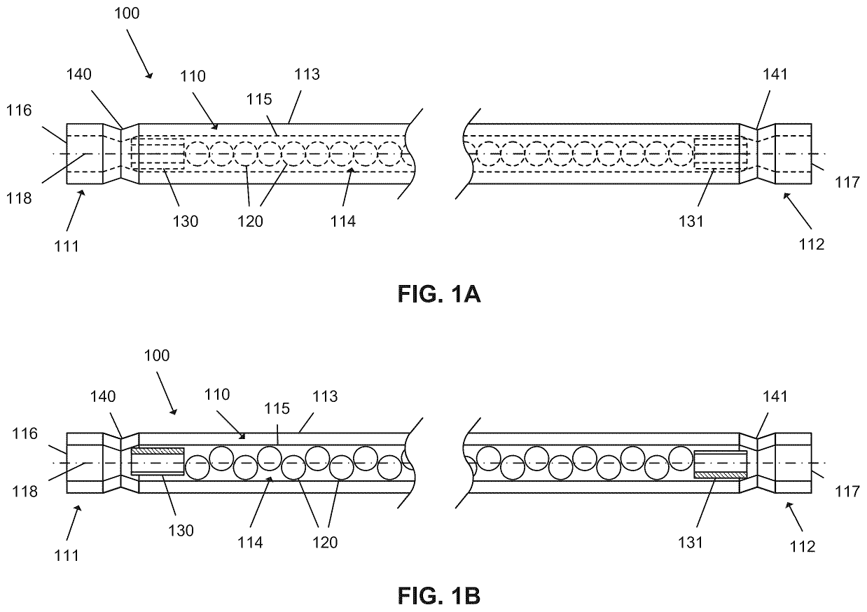

FIG. 1A illustrates, by a top-down view, an example of a static mixer 100 according to an embodiment of the present disclosure. The static mixer 100 comprises a tubular mixer body 110 and a mixing component including a plurality of spheroidal bodies 120. In this embodiment, the tubular mixer body 110 is a cylindrical tube having a first end 111, a second end 112 opposite the first end 111, and an outer surface 113. The tubular mixer body 110 defines a mixing chamber 114 having a chamber surface 115 that defines an inner diameter, a first end opening 116 at the first end 111, and a second end opening 117 at the second end 112. The mixing chamber 114 is configured to receive at the first end opening 116 a flow of two or more fluids and convey the flow towards the second end opening 117 where the flow can be discharged. The mixing chamber 114 further has a central axis 118 (indicated by the long dashed line) that spans from the first end opening 116 to the second end opening 117. In this embodiment, the tubular mixer body has a length of 203.20 mm and an outer diameter of 6.35 mm, and the inner diameter of the mixing chamber 114 is 3.97 mm. In this embodiment, the tubular mixer body is made of a PFA.

In the embodiment of FIG. 1A, each spheroidal body of the plurality of spheroidal bodies 120 is a sphere. The plurality of spheroidal bodies 120 are shown in FIG. 1A to be arranged sequentially along the central axis 118 with each spheroidal body 120 maintained in contact with each neighboring spheroidal body 120. The plurality of spheroidal bodies 120 is configured to permit the flow of two or more fluids through the mixing chamber 114 and induce a turbulence in the flow of the two or more fluids. In this embodiment, each spheroidal body 120 is made of a glass or quartz material and has a diameter of 3.00 mm, which corresponds to about 75% of the inner diameter of mixing chamber 114.

In the embodiment of FIG. 1A, the static mixer 100 further comprises a first stopper 130 positioned in the tubular mixer body 110 adjacent the first end 111 and a second stopper 131 positioned in the tubular mixer body 110 adjacent the second end 112. In this embodiment, each of the first stopper 130 and the second stopper 131 is prismatic, has a length of 5.50 mm, has a V-shaped cross section, and is made of a PFA. Each of the first stopper 130 and the second stopper 131 is designed to contain the plurality of spheroidal bodies 120 in the mixing chamber 114 and to admit the flow of the two or more fluids through the mixing chamber 114. In this embodiment, the first stopper 130 and the second stopper 131 are separated by 176.20 mm.

In the embodiment of FIG. 1A, the tubular mixer body 110 further has a first tapered portion 140 at the first end and a second tapered portion 141 at the second end. The first tapered portion 140 is configured to contain the first stopper 130 in the tubular mixer body 110 and the second tapered portion 141 is configured to contain the second stopper 131 in the tubular mixer body 110. The first tapered portion 140 and the second tapered portion 141 are each further configured to permit the flow of the two or more fluids through the mixing chamber 114.

The embodiment of FIG. 1A is symmetric about a plane between the first end 111 and the second end 112, such that mixing chamber 114 is further configured to, alternatively, receive at the second end opening 117 the flow of two or more fluids and convey the flow towards the first end opening 116 where the flow can be discharged

FIG. 1B illustrates the static mixer 100 described in relation to FIG. 1A by a cross-sectional side view. FIG. 1B shows the plurality of spheroidal bodies 120 sequentially arranged along the central axis 118 and staggered about the central axis 118. In other words, the plurality of spheroidal bodies 120 alternate between having their respective geometric centers above or below the central axis 118. Staggering of the plurality of spheroidal bodies 120 can cause the flow of the two or more fluids to meander in the mixing chamber 114.

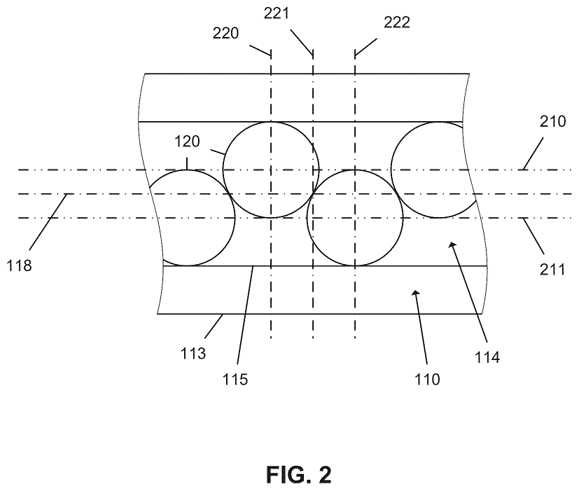

FIG. 2 illustrates a partial cross-sectional side view of the static mixer 100 described in relation to FIGS. 1A and 1B. A first group of spheroidal bodies 120 from among the plurality of spheroidal bodies 120 has their respective geometric centers positioned above the central axis 118 (indicated by a first dashed line 210), and a second group of spheroidal bodies 120 from among the plurality of spheroidal bodies 120 has their respective geometric centers positioned below the central axis 118 (indicated by a second dashed line 211). In this embodiment, the respective geometric center of each spheroidal body 120 is offset 0.97 mm from the central axis 118. FIG. 2 defines three transverse planes corresponding to points of contact for the plurality of spheroidal bodies 120: a first plane 220 located at a point of contact between one spheroidal body 120 of the first group of spheroidal bodies and the chamber surface 115; a second plane 221 located at a point of contact between the one spheroidal body 120 of the first group of spheroidal bodies 120 and one spheroidal body 120 of the second group of spheroidal bodies 120; a third plane 222 located at a point of contact between the one spheroidal body 120 of the second group of spheroidal bodies 120 and the chamber surface 115. Generally, for spheroidal bodies 120 having a same spherical shape and a same size, the point of contact corresponding to the second plane 221 is co-located with the central axis 118.

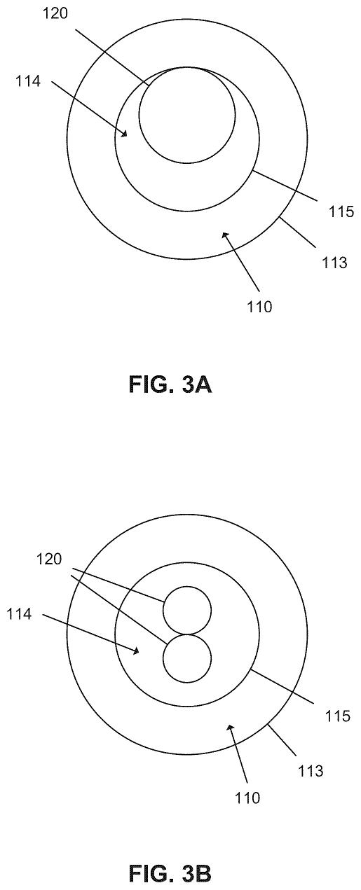

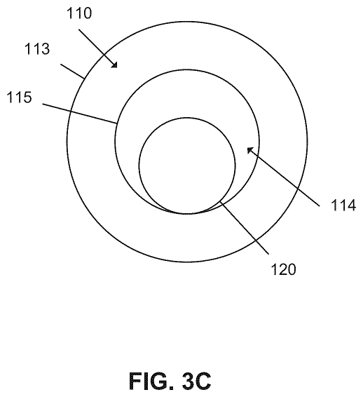

FIG. 3A illustrates a transverse cross-sectional view, at the first plane 220, of the static mixer 100 described in relation to FIGS. 1A and 1B. FIG. 3A shows the one spheroidal body 120 of the first group of spheroidal bodies 120 in contact with the chamber surface 115. FIG. 3B illustrates a cross-sectional view, at the second plane 221, of the static mixer 100. FIG. 3B shows the one spheroidal body 120 of the first group of spheroidal bodies 120 in contact with the one spheroidal body 120 of the second group of spheroidal bodies 120. FIG. 3C illustrates a transverse cross-sectional view, at the third plane 222, of the static mixer 100. FIG. 3C shows the one spheroidal body 120 of the second group of spheroidal bodies 120 in contact with the chamber surface 115. Each of FIGS. 3A, 3B, and 3C shows a singular space in the mixing chamber 114 for the flow of the two or more fluids. In this embodiment, the singular space has an area of 1.35 mm² at the first plane 220 and third plane 222, and an area of 10.9 mm² at the second plane 221.

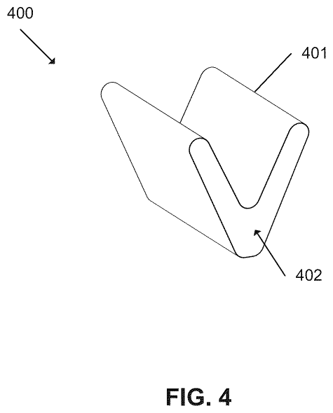

FIG. 4 illustrates an example of a stopper 400 according to an embodiment of the present disclosure. The stopper 400 may be used as the first stopper 130 and/or the second stopper 131 in a static mixer 100, as described in relation to FIGS. 1A and 1B. In this embodiment, the stopper 400 has a prismatic shape defining a length 401 and a V-shaped cross-section 402. In this embodiment, the stopper 400 is made of a PFA and the length is 5.50 mm.

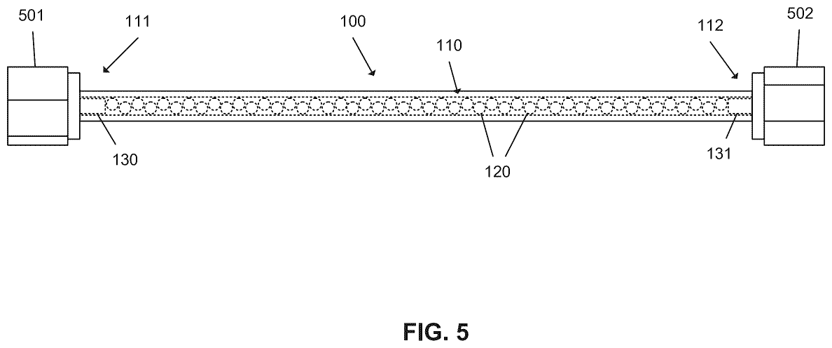

FIG. 5 illustrates an example of a static mixer 100 with fasteners, according to an embodiment of the present disclosure. The static mixer 100 may configured according the configuration described in relation to FIGS. 1A and 1B. The static mixer 100 includes a first fastener 501 positioned at a first end 111 of the static mixer 100 and a second fastener 502 positioned at a second end 112 of the static mixer 100 opposite the first end 111. In this embodiment, the first fastener 501 and the second fastener 502 are configured to respectively form, such as by swaging, a first tapered portion 140 of the static mixer 100 and a second tapered portion 141 of the static mixer 100. In this embodiment, each of the first fastener 501 and the second faster 502 have a threaded portion that can be used as a respective connection point for the static mixer 100 and are made of stainless steel. For example, the respective connection point of each of the first fastener 501 and the second fastener 502 can be used to fasten the static mixer 100 to a supply pipe and a drain pipe, respectively. In this embodiment, each of the first fastener 501 and the second fastener 502 are tube compression fittings that respectively produce the first tapered portion 140 and the second tapered portion 141 by necking the tubular mixer body 110 and narrowing the inner diameter of the tubular mixer body 110.

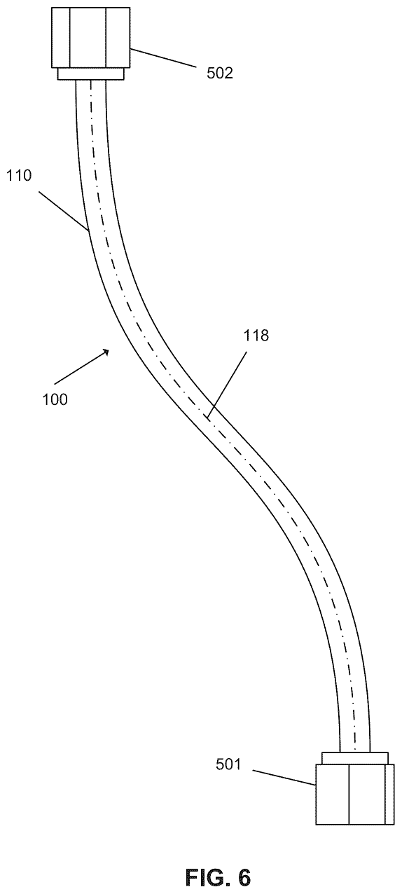

FIG. 6 illustrates an example of a static mixer 100 having a flexible tubular mixer body 110, according to an embodiment of the present disclosure. In this embodiment, the tubular mixer body 110 is made of a PFA material that can be bent or curved. The central axis 118 of the mixing chamber 114 (not shown) follows the bends or curves of the tubular mixer body 110. When the tubular mixer body 110 is bent or curved, the points of contact between each spheroidal body of the plurality of spheroidal bodies 120 are maintained; however, the location of each point of contact for each spheroidal body 120, with either a neighboring spheroidal body 120 or the chamber surface 115 of the mixing chamber 114, can change. In other words, the spheroidal bodies 120 may glide over one another to accommodate deformations to the tubular mixer body 110.

The design of the static mixer 100 of the present disclosure has been found to provide efficient mixing of two or more fluids to form a mixed fluid product. In particular, it has been established that the conversion of reactant molecules in a fluid sample (such as a conversion of NO and O₃ to NO₂ in a gas sample) can be achieved by a static mixer 100 having a short length and without increasing the pressure of the fluid sample.

Without being bound by theory, it is believed that the design of the static mixer 100 of the present disclosure provides a confined flow pathway for the two or more fluids to flow through such that the two or more fluids efficiently mix. It is believed that, as the flow of the two or more fluids meanders around each spheroidal body 120 and passes through areas of the mixing chamber 114 that are alternatively constricted or dilated, turbulence is induced in the flow of the two or more fluids to cause them to mix. With the changes in area of the mixing chamber 114, it is believed that the flow of the two or more fluids will experience local changes in pressure.

It has been observed that, for achieving a full conversion of NO and O₃ to NO₂ by mixing, a static mixer 100 of the present disclosure can have a length that is 10% of that of a conventional static mixer. It has further been observed that reducing the length of the conventional static mixer to 10% results in only 20% of the NO and O₃ being converted to NO₂.

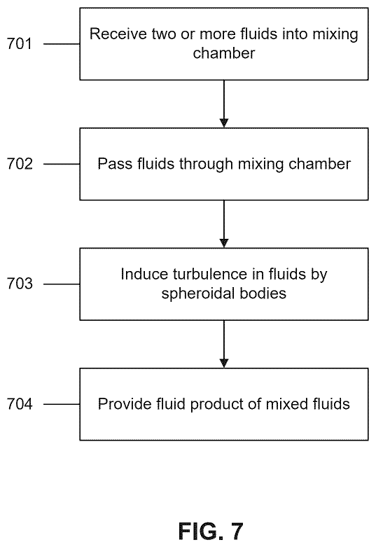

FIG. 7 illustrates a flowchart of a method for mixing two or more fluids to produce a fluid product using a static mixer 100 of the present disclosure, such as the static mixer 100 described in relation to FIGS. 1A and 1B. At action 701, a flow of the two or more fluids is received at the first end opening 116 of the tubular mixer body 110 of the static mixer 100. At action 702, the flow of the two or more fluids is passed through the mixing chamber 114 of the tubular mixer body 110 towards the second end opening 117 of the tubular mixer body 110. This includes passing the flow over the plurality of spheroidal bodies 120 and can include passing the flow through a first tapered portion 140, around a first stopper 130, around a second stopper 131, and through a second tapered portion 141. At action 703, turbulence is induced in the flow by the plurality of spheroidal bodies 120, causing the two or more fluids to mix. At action 704, the fluid product produced from the two or more fluids is provided at the second end of the tubular mixer body.

It is obvious that the foregoing embodiments of the disclosure are examples and can be varied in many ways. Such present or future variations are not to be regarded as a departure from the spirit and scope of the disclosure, and all such modifications as would be obvious to one skilled in the art are intended to be included within the scope of the following claims.

The scope of the claims should not be limited by the preferred embodiments set forth in the disclosure, but should be given the broadest interpretation consistent with the disclosure as a whole.

1. A static mixer for mixing two or more fluids to provide a fluid product, the static mixer comprising:
a tubular mixer body having a first end and a second end, the tubular mixer body defining a mixing chamber having a chamber surface defining an inner diameter, a first end opening, and a second end opening opposite the first end opening, the mixing chamber being configured to receive a flow of the two or more fluids into the first end opening of the tubular mixer body and convey the flow of the two or more fluids toward the second end opening; and
a mixing component comprising a plurality of spheroidal bodies located in the mixing chamber of the tubular mixer body, each of the plurality of spheroidal bodies having an outer diameter more than 50% of the inner diameter of the mixing chamber,
wherein each of the plurality of spheroidal bodies is maintained in contact with adjacent spheroidal bodies and with the chamber surface of the mixing chamber, and
wherein the plurality of spheroidal bodies is configured to induce turbulence in the flow of the two or more fluids to produce the fluid product when the two or more fluids are conveyed through the mixing chamber.

2. The static mixer of claim 1, wherein the fluid product is a mixture of the two or more fluids.

3. The static mixer of claim 1, wherein the fluid product is a product of a reaction between the two or more fluids.

4. The static mixer of claim 1, wherein the tubular mixer body is made of a transparent material.

5. The static mixer of claim 1, wherein the tubular mixer body is made of a flexible material.

6. The static mixer of claim 1, wherein each spheroidal body of the plurality of spheroidal bodies has a respective shape selected from the group consisting of spheres, polyhedrons, ellipsoids, and ovoids.

7. The static mixer of claim 1, wherein each of the plurality of spheroidal bodies is made of a material selected from the group consisting of glass, quartz, polymer, plastic, metal, rubber, and ceramic.

8. The static mixer of claim 1, wherein the plurality of spheroidal bodies includes a first set of spheroidal bodies having a first average outer diameter and a second set of spheroidal bodies having a second average outer diameter, wherein the first average outer diameter is different from the second average outer diameter.

9. The static mixer of claim 1, wherein:
the static mixer further comprises:
a first stopper positioned in the tubular mixer body adjacent the first end opening and configured to admit the two or more fluids into the mixing chamber; and
a second stopper positioned in the tubular mixer body adjacent the second end opening and configured to discharge the fluid mixture out of the mixing chamber;
wherein the first stopper and the second stopper are configured to retain the plurality of spheroidal bodies in the mixing chamber of the tubular mixer body.

10. The static mixer of claim 1, wherein the plurality of spheroidal bodies is arranged sequentially along and alternatingly about a central axis of the tubular mixer body by close packing of the plurality of spheroidal bodies in the mixing chamber.

11. The static mixer of claim 1, wherein the tubular mixer body has a first tapered portion at the first end of the tubular mixer body and a second tapered portion at the second end of the tubular mixer body, the first tapered portion and the second tapered portion being configured to contain the plurality of spheroidal bodies in the mixing chamber.

12. The static mixer of claim 1, wherein the mixing chamber has a length of between about 100 mm and about 2000 mm.

13. The static mixer of claim 1, wherein the inner diameter of the mixing chamber is between 1 and 10 mm.

14. The static mixer of claim 1, wherein the outer diameter of each one of the plurality of spheroidal bodies is between about 55% and about 95% of the inner diameter of the mixing chamber.

15. The static mixer of claim 1, wherein the plurality of spheroidal bodies includes from about 10 to about 2000 spheroidal bodies.

16. The static mixer of claim 1, wherein the two or more fluids include nitric oxide and ozone; and
the mixing chamber has a length sufficient to ensure that the nitric oxide and ozone mix, by the turbulence, to produce nitrogen dioxide as the fluid product is conveyed toward the second end opening of the tubular mixer body.

17. The static mixer of claim 1, wherein the two or more fluids include nitric oxide and ozone; and
the mixing chamber has a length sufficient to ensure that the nitric oxide and ozone mix, by the turbulence, to produce nitrogen trioxide as the fluid product is conveyed toward the second end opening of the tubular mixer body.

18. A method for mixing two or more fluids to produce a fluid product using the static mixer, as defined in claim 1, the method comprising:
receiving, by the first end opening at the first end of the tubular mixer body, a flow of the two or more fluids into in the mixing chamber of the tubular mixer body;
passing the flow of the two or more fluids through the mixing chamber toward the second end opening at the second end of the tubular mixer body;
inducing, by the plurality of spheroidal bodies positioned in the mixing chamber, turbulence in the flow of the two or more fluids to mix the two or more fluids; and
providing, at the second end of the tubular mixer body, a flow of the fluid product.

19. The method of claim 18 wherein the two or more fluids comprises ozone (O₃) andnitric oxide (NO) to produce the fluid product nitrogen dioxide (NO₂).
